(19) United States
(12) Patent Application Publication
(10) Pub. No.: US 2025/0274626 A1
(43) Pub. Date: Aug. 28, 2025

(54) ON-LINE CONTENT DISTRIBUTION SYSTEM

(71) Applicant: PSONAR Limited, Cambridge (GB)

(72) Inventor: Martin Paul Rigby, Cambridge (GB)

(73) Assignee: PSONAR Limited, Cambridge, GB (GB)

(21) Appl. No.: 18/822,642

(22) Filed: Sep. 3, 2024

Related U.S. Application Data
(63) Continuation-in-part of application No. 13/012,002, filed on Jan. 24, 2011, now abandoned.

(51) Int. Cl. H04N 21/266; H04N 21/239; H04N 21/258; H04N 21/472

(52) U.S. Cl. CPC H04N 21/266; H04N 21/2393; H04N 21/25866; H04N 21/472

(57) ABSTRACT

An on-line content distribution system includes a number of user terminals operable to enable a user to generate a request for a media file and associate the request with status data indicative of either a first status or a second status. An account database responds to receipt of a request from a user terminal to update account data, based on status data associated with the request. A content database stores media files and is configured to transmit data corresponding to the media file identified in a request by a user. The transmitted data may be formatted to inhibit the utilization of the transmitted media file more than a predetermined number of times without updating the account database. If the download request includes certain status data, it may permit utilization of the transmitted media file more than a predetermined number of times without updating the account database.

### BACKGROUND

Some embodiments relate to an on-line distribution of media content. In particular, embodiments of the present invention may concern the selection and distribution of on-line music and other media content via the Internet to mobile devices and media players.

Currently, media content, such as music and video data, is typically stored in electronic form and distributed electronically. This electronic storage and distribution reduces the costs involved in getting the media content to end-users.

iTunes™ by Apple, Inc. is one example of an existing media content delivery system. iTunes™ is a proprietary digital media player application used for playing and organizing digital music files. The application is also an interface to manage content on Apple's iPods™ and iPhones™. The iTunes™ application enables users to connect to the iTunes™ store. Using the iTunes™ application, an end user can purchase media files from the iTunes™ store. The media files are then downloaded onto a personal computer with an iTunes™ musical library installed and then transferred onto a user's iPod™ or iPhone™. A user then can cause the downloaded media file to be played and view the media file in the case of video files or listen to the media file in the case of music or sound files.

In addition to facilitating the downloading of media files onto user devices the iTunes™ application also supports user creation and selection of play lists. In the absence of a play list an iPod™ or iPhone™ can either randomly select stored media files for play or alternatively respond to a user selection of a specific file to be played. When a play list is generated using the iTunes™ application, a user identifies one or more songs that they desire to listen to. The application then proceeds to play those songs either in a specified order or in a random order.

An alternative approach to music delivery is exemplified by the Pandora® Radio System, which provides a music streaming service. At the core of the Pandora® Radio system is an automated music recommendation system. Users enter a song or artist they enjoy and the service responds by playing selections that are musically similar. More specifically each music track available through the Pandora® Radio system is analyzed based on a number of musical attributes such as rhythm syncopation, key tonality, vocal harmony etc. This data provides a measure of musical similarity between two different tracks. The Pandora® Radio system also prompts users to provide feedback on approval or disapproval of individual songs which are played in response to a user's initial identification of a song or artist. This feedback is combined with the musical similarity measures to help select future songs, which are then provided to users via a streaming service.

Last.fm is another example of an existing musical delivery system. Last.fm is a digital rights management based music streaming service. Using the system, users can access a large database of music by track title, artist, album, record label and genre. Additionally users can also generate play lists detailing the music that they which to listen to. The selected music is then streamed to a user's device.

Existing music distributions systems exemplify different approaches to obtaining a revenue stream. In the case of the iTunes system, the sale of music downloads provides the system's primary revenue stream. Individual music tracks are made available for purchase at a cost of between $0.69 and $1.29. Once purchased a media file encoding the selected track, such as an mp3 or acc file, is made available for download onto a user's system. The data is then transmitted and stored on a user's device where it is available for use and re-use.

The Pandora® Radio and Last.fm systems take a different approach. In contrast to the iTunes™ system where complete media files are transmitted to an end user, both Pandora® Radio and Last.fm are examples of music streaming systems. In the Pandora® Radio and Last.fm systems an end user is only ever provided with a transitory copy of a music track, which is immediately over written as more data is sent to an end user's phone or computer. As the end user is not provided with a permanent copy of a media file no purchase is made. Rather the systems are supported through a combination of advertising which is included in the data stream sent to end user's and also through requiring user's to pay a subscription charge for the music streaming service. Various subscription rates tend to be available and users are able to reduce the amount of advertising, which is included in a data stream by paying a higher subscription. The income streams from paid for advertising and subscription payments can then be supplemented by a separate service selling complete music tracks in a similar way to iTunes™.

Existing systems are faced with a common problem, which is how to identify music tracks that a user may be interested in listening to. In the case of Pandora® Radio and Last.fm identifying similar tracks enables the music streaming system to provide a download stream, which a listener likes and hence justifies the user continuing to listen to and potentially pay for the service provided. In the case of system such as iTunes™, identifying additional music which might be of interest enables a user to be presented advertising which can encourage the user to purchase new track downloads.

One approach to addressing this problem is to obtain detailed data about music tracks in terms of artist, genre and musical attributes. Such an approach enables a system to identify similar musical tracks because of such shared characteristics. Although generally quite successful, this approach can have limitations. Frequently users like a variety of different types of music and such tastes can vary depending upon mood. Identifying music, which is merely “more of the same” does not account for the fact that on various occasions a user might wish to hear something a bit different.

Another approach, which attempts to address the variability of user's tastes, is to utilize data concerning purchases by other users. Where two users purchase or select the same track to be played, it is possible that they will also like other tracks purchased by one another other. To facilitate such an approach, algorithms can be provided to analyze such purchase or selection data to identify “similar” purchasing or selection behavior, which might indicate a similarity of tastes. Such an approach does, however, suffer from limitations since many purchases will identify merely the most popular choices, rather than providing useful information about users' shared tastes or interests.

A different approach is one based on user generated play lists. Particularly in the case of streaming based systems such as Pandora® Radio and Last.fm users are able to generate play lists identifying music they wish to listen to. In addition to structuring the content, which is streamed to an individual user, such play lists can also be shared between users. Sharing play lists enables users to provide a recommendation of new music, which their friends may be interested in.

In the case of download-based systems, such as iTunes™, play lists are created by users. However, the use of such play lists in download based systems is limited as although new music can be identified, the cost of purchasing a track out right can act as a disincentive for a user to purchase a track solely on the basis of a recommendation without ever having heard the track.

In view of the above, an alternative music distribution system is desirable which addresses at least some of the limitations of existing systems.

### SUMMARY

In accordance with one aspect of the present invention, a method of distributing media content comprises: providing an account database associating users with account data; providing a content database storing a plurality of media files; receiving a download request from a user for a media file stored in the content database wherein said download request includes data identifying a media file stored in the content database and status data indicative of either a first status or a second status; updating the account data associated with a user making the request on the basis of the status information included in the request; transmitting data corresponding to the media file identified in the received request to a user; and inhibiting the utilization of the transmitted media file more than a predetermined number of times without updating the account database if the download request includes status data indicative of said first status; and permitting utilization of the transmitted media file more than a predetermined number of times without updating the account database if the download request includes status data indicative of said second status.

In some embodiments, inhibiting the utilization of a transmitted media file more than a predetermined number of times without updating the account database if the download request includes status data indicative of said first status may comprise inhibiting the utilization of the transmitted media file more than once without updating the account database if a download request includes status data indicative of said first status. In such embodiments the data transmitted in response to a request including status data indicative of said first status may comprise data in a form which prevents the data from being used more than once. Alternatively the data transmitted in response to a request including status data indicative of said first status may comprise a data stream, which is overwritten subsequent to use thereby preventing the data from being reused more than once.

In some embodiments, transmitting data corresponding to the media file may include transmitting data which identifies the number of times a media file can be used. In such embodiments the method may further comprise receiving an instruction to play a received media file; determining the number of times a received media file is permitted to be used on the basis of the data transmitted with the media file; and playing the received media file if the media file has not been played more than the permitted number of times.

If it is determined that a received media file has been played the permitted number of times, the method may additionally comprise generating a further download request for a media file; updating the account data associated with the user making the request on the basis of the generated request; and transmitting data to a user enabling the user to play the media file at least one more time without updating the account database. The transmitted data enabling the user to play the media file at least one more time may comprise data identifying the number of additional times the user can play said media file without updating the account database. Alternatively transmitting data enabling the user to play the media file at least one more time without updating the account database may comprise transmitting a further copy of the media file to the user to enable the user to play the media file at least one more time without updating the account database.

In some embodiments, updating the account data associated with a user making a request may comprise: checking whether account data associated with the user making the request exceeds a predetermined amount; and responding to a determination that the account data exceeds the predetermined amount by decrementing the account data. If the account data does not exceed the predetermined a user may be presented with a user interface enabling the user to make an additional payment. Transmission of data to the user to enable the user to utilize a requested media may be prevented until confirmation that a payment is being made has been received and the account database has been updated.

When decrementing account data, account data may be decremented by a first amount if a download request includes data indicative of a first status associated with limited permitted use or by a second amount if a download request includes data indicative of a second status indicative of unlimited permitted use wherein the second amount is greater than the first amount.

Permitting the utilization of the transmitted media file more than a predetermined number of times without updating the account database if the download request includes status data indicative of said second status may comprise permitting the utilization of the transmitted media file an unlimited number of times without updating the account database if a download request includes status data indicative of said second status. In some embodiments, this may be achieved by responding to a further download request from a user for a media file by determining whether a user has previously received data corresponding to the media file in response to a request including status data indicative of a second status; and if so transmitting data corresponding to the media file identified in the received request to the user without updating the account data associated with the user. Alternatively, in other embodiments, the data corresponding to a media file transmitted in response to a request including status data indicative of said second status may comprise data in a form which permits the data to be used multiple times.

In another aspect, a method of distributing media content comprises: providing an account database associating users with account data; providing a content database storing a plurality of media files; receiving a play list from a first user, identifying a second user and one or more media files stored in the content database wherein each of said one or more media files is identified with status data indicative of either a first status or a second status; updating account data associated with the first user on the basis of the status data associated with media files in the playlist; transmitting data identifying the one or more media files in the play list to the second user; responding to a down load request from the second user for a media file included in the play list by: transmitting data corresponding to the media file identified in the request; inhibiting the utilization of the transmitted media file more than a predetermined number of times without updating the account database if a media file has previously been associated with status data indicative of said first status; and permitting utilization of the transmitted media file more than a predetermined number of times without updating the account database if the media file is associated with status data indicative of said second status.

In a further aspect, an on-line method of distributing media content comprises: providing an account database associating users with account data; providing a content database storing a plurality of media files; receiving a download request from a user for a media file stored in the content database; updating the account data associated with a user; transmitting data corresponding to the media file identified in the received request to a user; and inhibiting the utilization of the transmitted media file more than a predetermined number of times without updating the account database

In accordance with another aspect, a computer network comprises: a user terminal operable to enable a user to generate a request for a media file and associate the request with status data indicative of either a first status or a second status; an account database associating users with account data and responsive to receipt of a request from a user terminal to update account data associated with a user making the request on the basis of the status data associated with the request; a content database storing a plurality of media files; and a communications system operable to transmit data between said user terminal; said account database and said content database, wherein the content database is responsive to receipt of a request from a user terminal and the updating of the account database to transmit data corresponding to the media file identified in the received request to a user, the data transmitted being such to inhibit the utilization of the transmitted media file more than a predetermined number of times without updating the account database if a download request includes status data indicative of said first status; and permit utilization of the transmitted media file more than a predetermined number of times without updating the account database if the download request includes status data indicative of said second status.

In some embodiments, the content database may be configured to transmit data corresponding to a media file transmitted in response to a request including status data indicative of said first status as a data stream, which is overwritten subsequent to use thereby preventing the data from being reused more than once.

Alternatively, the content database may be configured to transmit data corresponding to a media file transmitted in response to a request which includes transmitting data which identifies the number of times a media file can be used. In such an embodiment a player program may be provided on the user terminal. The player program may then be responsive to receipt of user input to play a received media file to determine the number of times a received media file is permitted to be used on the basis of the data transmitted with the media file; and play the received media file if the media file has not been played more than the permitted number of times.

In such an embodiment, if a player program determines that a received media file has been played a permitted number of times, the player program may respond by generating a further download request for said media file and causing said further download request to be sent to the accounts database. The accounts database may then respond to receipt of such a request by updating the account data associated with the user making the request on the basis of the generated request; and cause the content database to transmit data to the user terminal enabling a user to play the media file at least one more time.

In some embodiments, the account database may be configured to be responsive to a request for a media file to update the account data associated with a user making a request by: checking that account data associated with the user making the request exceeds a predetermined amount; responding to a determination that the account data exceeds the predetermined amount by decrementing the account data. If the account data does not exceed the predetermined amount the user terminal may then present the user with a user interface to make an additional payment and the account database may then respond to receipt of confirmation that a payment is being made by updating the account database. The content database can be prevented from dispatching data to a user until the account database has been updated.

When updating the accounts database in response to a download request, the accounts database may be configured to decrement the account data by a first amount if a download request includes data indicative of a first status or by a second greater amount if a download request includes data indicative of a second status.

In some embodiments, the account database may be responsive to receipt of a further download request from a user for a media file to determine whether the user has previously received data corresponding to the media file in response to a request including status data indicative of a second status; and if so transmit data corresponding to the media file identified in the received request to the user without updating the account data associated with the user.

In some embodiments, multiple user terminals may be provided. In such embodiments, at least some of the user terminals may be operable to enable a first user to input data defining a play list identifying one or more media files stored in the content database and associate the identified media files with status data indicative of either a first status or a second status together with data identifying a second user. The account database may then be responsive to receipt of a playlist to update account data associated with the first user on the basis of the status data associated with media files in the playlist an transmit data identifying the media files in the playlist to a user terminal associated with the second user. After a content list has been dispatched the content database may then be responsive to receipt of a download request from the second user for a media file included in the playlist to: transmit data corresponding to the media file identified in the request; inhibit the utilization of the transmitted media file more than a predetermined number of times without updating the account database if the download request includes status data indicative of said first status; and permit utilization of the transmitted media file more than a predetermined number of times without updating the account database if the download request includes status data indicative of said second status.

In another aspect, a computer network comprises: a user terminal operable to enable a user to generate a request for a media file; an account database associating users with account data and responsive to receipt of a request from a user terminal to update account data associated with a user making the request; a content database storing a plurality of media files; and a communications system operable to transmit data between said user terminal; said account database and said content database, wherein the content database is responsive to receipt of a request from a user terminal and the updating of the account database to transmit data corresponding to the media file identified in the received request to a user, the data transmitted being such to inhibit the utilization of the transmitted media file more than a predetermined number of times without updating the account database.

In another aspect of the present invention, a computer system comprises: a control module operable to receive a request for a media file from a user, said request being associated with either a first status or a second status; an account database associating users with account data and responsive to receipt of a request for a media file from a user to update account data associated with the user making the request on the basis of the status data associated with the request; and a content database storing a plurality of media files; wherein the content database is responsive to receipt of a request for a media file and the updating of the account database to cause data corresponding to the media file identified in the received request to be transmitted to a user, the data transmitted being such to inhibit the utilization of the transmitted media file more than a predetermined number of times without updating the account database if a download request includes status data indicative of said first status; and permit utilization of the transmitted media file more than a predetermined number of times without updating the account database if the download request includes status data indicative of said second status.

In some embodiments, the content database may be configured to transmit data corresponding to a media file in response to a request including status data indicative of said first status as a data stream, which is overwritten subsequent to use thereby preventing the data from being reused more than once.

In some embodiments, the content database may be configured to transmit data corresponding to a media file in response to a request including status data indicative of said first status together with data, which identifies the number of times a transmitted media file can be used.

In some embodiments, the accounts database may be configured to update account data associated with a user making the request on the basis of the status data associated with the request by decrementing the account data by a first amount if a download request includes data indicative of a first status and decrementing the account data by a second amount if a download request includes data indicative of a second status wherein the second amount is greater than the first amount.

In some embodiments, the account database may be configured to be responsive to receipt of a further download request from a user for a media file to determine whether the user has previously received data corresponding to the media file in response to a request including status data indicative of a second status; and if so transmit data corresponding to the media file identified in the received request to the user without updating the account data associated with the user.

In another aspect of the present invention, a non-transitory computer readable medium stores computer interpretable instructions, which when interpreted by a programmable computer cause the computer to become configured as described above.

### BRIEF DESCRIPTION OF THE DRAWINGS

Embodiments of the present invention will now be described in detail with reference to the accompanying drawings in which:

FIG. 1 is a schematic block diagram of an on-line content distribution system;

FIGS. 2A and 2B are flow diagrams illustrating the processing undertaken by the on-line content distribution system of FIG. 1;

FIG. 3 is a flow diagram of the processing undertaken when a first user provides a play list of paid for content to a second user.

FIG. 4 is a flow diagram of steps for determining whether a user has permission or credits to play a media file in accordance with an embodiment.

FIG. 5 is a flow diagram of steps for determining whether a user has permission or credits to play a media file in accordance with an alternative embodiment.

### DETAILED DESCRIPTION

### I. Overall Description of Embodiments

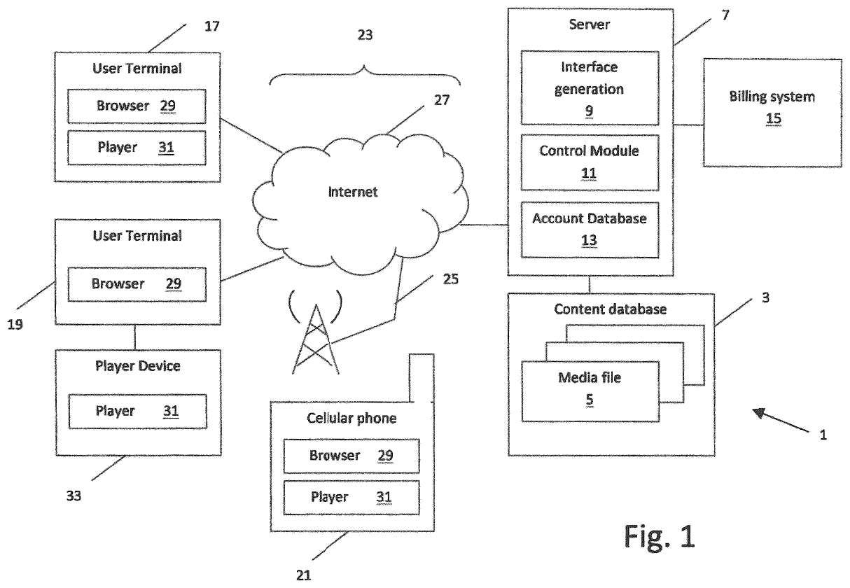

Referring to FIG. 1, an on-line content distribution system 1 is provided. The on-line content distribution system 1 comprises a content database 3 storing media content files 5, such as sound files encoding musical tracks or video images. The content database 3 is connected to a server 7. The server 7 is configured into a number of functional modules comprising an interface generation module 9; a control module 11 and an accounts database 13. The server 7 is also connected to a billing system 15 and is accessible by a number of user terminals 17-21 via a communication system 23. In this embodiment, the user terminals 17-21 comprise computers 17,19 and a mobile cellular telephone 21 and the communications system 23 comprises a cellular telephone network 25 and the Internet 27.

A browser program 29 is provided in memory of each of the user terminals 17-21. As will be described in more detail below, the browser program 29 enables each of the user terminals 17-21 to interact with the interface generation module 9 to cause a user interface enabling a user to identify a media files 5 stored on the content database 3 that they wish to access to be displayed. The interface generation system 9 also enables a user to indicate the manner in which a user wishes to be charged for obtaining access to selected media file 5. When a selection of a media file 5 and status data indicating the selected charging system is received by the server 7, the control module 11 then proceeds to update the accounts database 13 and causes the content database 3 to provide a copy of the requested media file 5 to the user terminals 17, 19, 21 requesting the media file 5. The obtained copy can then be played using a player program 31 provided either in the memory of the user terminal 17, 21 receiving the requested media file 5 or passed to a player device 33 connected to the user terminal 19 which itself contains a player program 31.

Subsequently, after the requested media file 5 has been played, as will be described in more detail below, the content database 3, the player program 33 and the server 7 interact so that the status data associated with a request for a media file 5 determines whether a user can utilize the requested media file 5 on further occasions without the accounts database 13 being updated. The described system thereby enables a differential charging structure to be implemented whereby users can be charged different amounts to be provided with unlimited access to a media file or alternatively to be charged a lesser amount each time a file is accessed.

The described system also facilitates the recommendation and sharing of media files. More specifically, one user can generate a list of recommended media files 5 for another user to access and play. When creating the recommended list, the first user can pay for the second user to be provided with access to the recommended media files 5 a limited number of times before incurring additional charges. As only a limited amount of use is provided the costs for providing others with paid for access to media can be significantly lower than that required under media distribution systems.

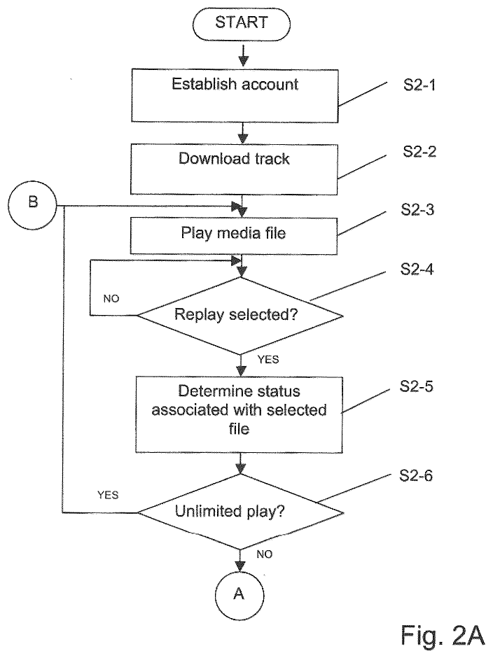

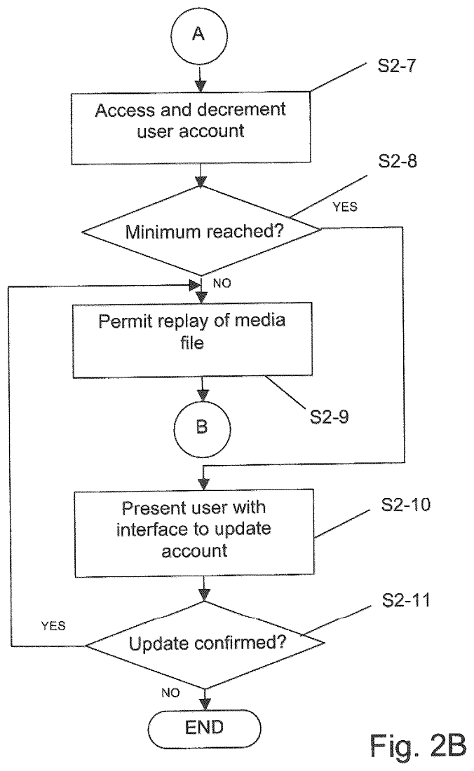

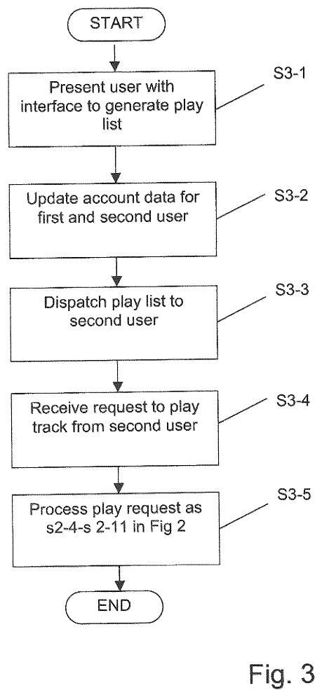

The processing undertaken by the on-line distribution system 1 will now be described with reference to the flow diagram of FIGS. 2A and 2B.

Referring to FIG. 2A, initially in order to utilize the system 1, a user is required to establish (s2-1) an account. In this embodiment, this is achieved by a user utilizing a browser 29 to access the interface generation module 9 on the server 7. The interface generation module 9 then causes a user interface to be displayed on the screen of the user terminal 17-21 accessing the server 7. This can be achieved by the browser 29 being a conventional browser program and the interface generation module 9 being a conventional website. Alternatively, in other embodiments, the same effect can be achieved by the interface generation module 9 providing an application, which is downloaded on a user terminal 17, 19, 21 and provides a similar functionality.

The user interface displayed by the user terminal 17, 19, 21 will then enable the user to enter basic information to establish an account. Typically such information will include a user name, a password, an e-mail address and billing information. This billing information can either be for example the credit card information required to execute a credit card transaction or alternatively where the user terminal being utilized is a cellular phone, data necessary in order to make a charge to a telephone bill. Having obtained this information, the information is sent from the user terminal 17, 19, 21 to the server 7 and a user record is established in the account database 13. The user record, in this embodiment will also include a credit amount. Having established the user record in the account database 13, the control module 11 then proceeds to utilize the received billing information to instruct the billing system 13 to execute a billing transaction for the initial credit amount.

Thus, for example, a user record of the following format might be created and stored in the account database 13:

| User Name: | J Smith |
|---|---|
| Password | 1234ABCDE |
| Billing details | Visa Credit Card No 1212-2222-3333-4444 |
| | Name on Card: J SMITH |
| | Billing address: 57 Acacia Avenue |
| | Anytown, MD 9999-9999, USA |
| Current Credit | $10.00 |

In the case of such a record, the billing system would proceed to charge the $10 using the obtained billing information. Charging in this way reduces overall transaction costs as the credit on the system can be charged in blocks of a certain value and hence avoids making transactions for very small amounts.

Having established an account, a user is then invited to down load (s2-2) and play a media file 5. More specifically, the interface generation module 9 causes the browser 29 to present a user interface enabling a user to select from a menu identifying the media files 5 stored in the content database 3. For each of the files the user is prompted to identify whether they wish to have unlimited access to the file or alternatively to be charged for each use of the file. Both options will be associated with one or more charges. Thus, for example, a charge of $0.99 might be associated with unlimited use of a media file 5 whereas the alternative might be a charge of $0.10 per play for using the file on a single occasion.

Having identified a media file 5 and whether the use desires unlimited use or to pay for each use, this data is then transmitted from the user terminal 17,19,21 to the server 7. The control module 11 then proceeds to instruct the account database to debit the users account by the amount associated with the user's selection and record in the user's account record the access that the user has purchased.

Thus, at this stage, a user's record might appear as the following after a user has selected two files for access, one for unlimited use and one for being charged for each use:

| User Name: | J Smith |
|---|---|
| Password | 1234ABCDE |
| Billing details | Visa Credit Card No 1212-2222-3333-4444 |
| | Name on Card: J SMITH |
| | Billing address: 57 Acacia Avenue |
| | Anytown, USA |
| Current Credit | $8.89 |

Selected tracks

| | |
|---|---|
| Track 1 | Unlimited play |
| Track 2 | Pay per play |

Having updated the user record in the account database 13, the control module 11 then makes a copy of the selected media files 5 available to the user terminal 17, 19, 21.

This can be done in a number of ways depending upon the details of the system 1. In the present embodiment, the media file 5 is transmitted to the user terminal 17 together with data identifying the number of times the media file 5 can be utilized. This copy of the media file 5 is then stored in the memory of the user terminal 17, 21 or the player device 33 connected to the user terminal 19 and when a user wishes to play the media file (s2-3), the player program on the user terminal 17, 21 or player device 33 is invoked and then proceeds to play the downloaded media file 5.

Having played the media file 5 the player program 31 then waits (s2-4) until the user indicates that they wish the media file 5 played again. When the player program 31 is instructed to replay a media file 5, before playing the file 5 the player checks (s2-5, s2-6) the status data associated with the file 5 which indicates the number of times a file can be played without incurring an additional charge.

If the selected media file 5 is associated with data indicating that the file 5 can be reused without additional charge, the player 31 then proceeds to play (s2-3) the file 5 before again waiting for user input (s2-4) to ask for the media file to be reused.

If, however, the player 31 determines the media file 5 has already been used the paid for number of times, the player 31 the accesses the account database 13 on the server 7. The control module 11 then (s2-7) proceeds to decrement the users account by the amount associated with the pay per play option and checks (s2-8) whether this causes the users account to reach a minimum amount. If the minimum amount has not be reached the control module 11 then (s2-9) sends a signal to the player program 31 to permit the player program to re-utilize the received media file 5 and the player program 31 then plays (s2-3) the media file 5.

Thus, in this way, a user's account is debited each time the media file associated with limited play is activated. The system described enables a user to utilize the available file automatically provided credit associated with the user is available.

If the control module 11 determines (s2-8) that a user's account has reached the minimum level, the control module 11 then causes the user interface module 9 to cause (s2-10) the user terminal 17, 19, 21 to display a user interface requesting that a user confirm that they wish to top up their account. If a user confirms that this is acceptable, the control module 11 causes the billing system 15 to be invoked to utilize the billing information associated with the user to action another transaction for a specified amount and the account data associated with the user is updated to reflect the purchase of additional credit. This having been completed, the control module 7 then sends a signal to the player 31 attempting to play the selected media track to instruct the track to be played.

It will be appreciated that preventing a player program 31 from playing a track unless account data is updated or a user has purchased unlimited use of a track could be achieved in a number of ways. In some embodiments, as described above, the player program 31 could be designed to check status data prior to playing a media file. In other embodiments rather than providing a user terminal 17 with data representing a complete media file 5 data could be streamed to a user terminal 17, 19, 21 when requested where the streamed data is stored only on a temporary basis. In such an embodiment, whenever a media file 5 was to be replayed new data would need to be obtained from the server 7 and the content database 3 as previously obtained data will have been over written whilst being utilized.

It will, however, be appreciated that providing complete media files 5 which are associated with a set number of permitted plays provides the system with a number of advantages. In particular such an approach separates the need for a device to connect to the server 7 when a track is to be played. Thus, such an approach reduces the amount of data transfer required. Additionally such an approach facilitates asynchronous play of media tracks 5 where a media track is downloaded and then played at a different time.

The above described system also facilitates the sharing of recommended media tracks between users as will now be described with reference to FIG. 3.

As has been noted above in a conventional on-line distribution system, such as iTunes™, it is possible for users to transfer play lists to other users as a way of recommending tracks for purchase. Users can also provide one another with gift cards to facilitate the purchase of tracks identified in play lists. However, as iTunes involves the purchase of a media file 5 without restrictions on the number of times the file is played, such purchases are relatively expensive.

In contrast to such existing systems, the present embodiments facilitate the purchase of limited use or access to certain media files and hence enables users to provide recommendations to others at much lower cost. Such recommendations also facilitate subsequent purchase of a full use track as users are able to try out a recommended media file 5 prior to purchasing an unrestricted use file.

In such a system, initially (s3-1), a user utilizes a browser program 29 to access the interface generation module 9 on the server 7. This then causes the user to be presented with a user interface enabling the user to create a play list and associate the various media files 5 in the play list with status data. More specifically, a user can select from an index of the media files 5 stored in the content database 3 and associate each file with a status indicating limited or unlimited use. The user then identifies an address for a second user to whom the play list is to be sent.

When data identifying the selected tracks and the second user is sent to and received by the server 9 the control module 11 then (s3-2) causes the account database 13 to be updated. More specifically the account data for the first user is debited to reflect the purchase of the tracks identified in the playlist and the record for the second user is updated to reflect a right to utilize those tracks.

Thus, for example, say a first user was to send the following data to the server 7:

| | |
|---|---|
| User Name: | J Smith |
| Password | 1234ABCDE |

Play list

| | |
|---|---|
| Track 3 | Unlimited play |
| Track 4 | Pay per play |
| Second User: | J Jones |

Current credit for the user J Smith would be updated to account for the purchase of access to track3 and track 4. The account data base would then update the account database for J Jones to include the data identifying Track 3 and track 4 as selected tracks where track 3 was associated with unlimited play and track 4 was associated with limited play.

Having updated the two account records, data identifying track 3 and track 4 and their associated statuses is then dispatched (s3-3) to the second user. Having received this play list the second user can then utilize a player program 31 to play any of the listed tracks. When a track is selected for play a request (s3-4) is dispatched from the second user to the server 7, which identifies the selected track. The control module 11 then processes the request in a similar way to the manner in which a request for a media file 5 is processed as has been described in steps s2-4-s2-11 in FIG. 2.

Thus, in this way, a first user is able to select a set of media files which are to be made available for use by a second user.

### II. Detailed Explanations of Various Processor Implemented Steps, Including: Receiving, Updating, Transmitting, Inhibiting, and Permitting

The processor implemented step of receiving is performed in accordance with various embodiments as follows.

The content distribution system 1 includes a server 7 which is configured to receive information through a communications system 23. The communications system 23 can be a network, including but not limited to the Internet 27. The information can be received from any network-connected device. Individual embodiments of the system can include receipt of information from personal computers and mobile cellular devices.

In an embodiment, the server 7 and the user terminals are connected to the same communications system 23 and therefore can communicate through a network. For example, the network can be a private local network where the information can only be transmitted and received within the network. In this embodiment, the server 7 can only receive information from user terminals in the same closed network.

In an embodiment utilizing the Internet, the server 7 can receive information such as a download request through the Internet 27, which is part of the communications network 23. The Internet 27 is a network of networks, and therefore the server and devices are not required to be connected to the same network as long as the individual networks are all connected to the Internet. The information can come from any Internet-capable device, including but not limited to personal computers and mobile phones. The devices must be connected to the Internet in order to send and receive information, and the server 7 must be connected to the Internet in order to receive the information.

Furthermore, the method of Internet connection can vary depending on the type of device. For example, most personal computers and mobile phones have Wi-Fi capabilities, which allow the devices to connect to the Internet. Many computers have ethernet ports, allowing for the use of a wired Internet connection using an ethernet cable. Mobile phones can utilize their cellular networks to connect to the Internet, making use of cellular towers and other transceivers. Satellite Internet access can be accomplished through the use of communication satellites and satellite dishes. The ubiquitous nature of the Internet 27 allows for the server 7 to be able to receive information from the user terminals in a wider range of places, as long as there is a method of connecting the user terminals to the Internet 27.

In an advanced embodiment, the system's request handling begins with the implementation of a robust multi-layered validation framework designed to scrutinize every incoming request. This framework operates by first parsing the request to confirm that it adheres to the expected format and includes all necessary parameters. Missing or malformed parameters trigger immediate rejection of the request, which is then logged for further analysis. This early rejection prevents unnecessary processing of invalid requests, optimizing system performance.

Following format validation, the system performs authentication checks, ensuring that the request originates from a legitimate, authenticated user. This involves validating session tokens or API keys against a secure authentication database. If authentication fails, the system not only denies the request but also records the attempt, potentially flagging the user account for further scrutiny or security actions.

The system next applies rate-limiting mechanisms to prevent abuse, such as denial-of-service attacks, by monitoring the frequency of requests from a single source. Should a user exceed the allowed threshold, subsequent requests are throttled or blocked. This proactive measure maintains system stability and ensures equitable resource distribution among users.

To protect against injection attacks, the system employs sophisticated sanitization techniques. For example, SQL queries are constructed using parameterized statements, where user inputs are treated as data rather than executable code. This approach effectively mitigates the risk of SQL injection, as the inputs cannot alter the structure of the database queries. Similarly, inputs that are included in HTML output undergo rigorous encoding to neutralize potential cross-site scripting (XSS) attacks.

Additionally, the system enforces strict input validation rules. For instance, text fields are restricted to a predefined set of characters, while numeric fields are checked for valid ranges. Complex inputs, such as JSON objects, are validated against a schema that defines the structure, data types, and constraints expected by the system.

In certain embodiments, the system also supports the encryption of all data transmitted between the user terminal and the server, leveraging HTTPS and other secure communication protocols. This encryption ensures that sensitive data, such as user credentials or payment information, is protected from interception during transmission. The use of Transport Layer Security (TLS) further guarantees that the data remains confidential and untampered with.

To enhance security, the system includes logging mechanisms that capture details of each request, including the source IP address, request type, and timestamp. These logs are stored securely and are analyzed in real-time to detect and respond to potential security threats. The system can automatically block IP addresses exhibiting suspicious behavior, such as repeated failed authentication attempts, thereby preventing further attacks.

By combining these validation, sanitization, and security protocols, the system ensures that only legitimate, well-formed requests are processed, thereby safeguarding the integrity and availability of the service.

The information that the communications system 23 receives includes requests for downloading a file and the status of the file. The user of the user terminal can send this information to the communications system 23 to request a media file stored in the content database 3. The request will be sanitized and validated to prevent problems with the database.

The request of the media file includes data that identifies the media file stored in the database to ensure the correct file is requested. The communications system 23 also receives purchase information for the media file, which defines whether the media file has a limited or unlimited number of plays. If the media file has a limited number of plays, the number of plays remaining is also included.

Upon receipt of a media file request, the system first classifies the request based on its HTTP method. GET requests are typically used for downloading media files, especially those with unlimited play status, while POST requests are reserved for actions that modify the server's state, such as purchasing additional plays or updating user information.

The system's logic for handling GET requests begins by verifying the user's access rights to the requested media file. This involves checking the user's account status, including their subscription level or any prior purchases related to the file. If the user has previously purchased unlimited access to the file, the system retrieves the file from the content database and initiates a direct download to the user terminal.

For POST requests, the system performs a series of updates to the account database. When a user opts to purchase additional plays for a media file, the system first verifies that the user's account balance is sufficient to cover the transaction. If funds are available, the system deducts the appropriate amount and increments the play count for the file. This transaction is logged for audit purposes, ensuring transparency and traceability.

The system also handles scenarios where the user attempts to access a media file with limited play status. In these cases, the system tracks the number of plays remaining for the file, decrementing the count each time the file is accessed. To maintain consistency, the system employs distributed locking mechanisms to ensure that simultaneous requests from the same user do not result in conflicting updates to the play count. Once the play count reaches zero, the system automatically restricts further access to the file and prompts the user to purchase additional plays.

In some embodiments, the system supports pre-fetching of media files to improve playback performance. When a user initiates a request for a file, the system can begin downloading or buffering the file in the background while the user completes the transaction or waits for the file to be available. This pre-fetching reduces latency and ensures a smoother playback experience.

To optimize performance, the system may also implement caching strategies, where frequently accessed media files are temporarily stored in a cache to reduce the load on the content database. When a cached file is requested, the system can serve the file directly from the cache, bypassing the need for a database query and significantly reducing response time.

The system's architecture is designed to be scalable, supporting large volumes of simultaneous requests without degradation in performance. This is achieved through load balancing techniques that distribute requests across multiple servers. Each server operates independently, yet in concert with others, to ensure that no single server becomes a bottleneck.

In certain embodiments, the system includes a recommendation engine that suggests additional media files to the user based on their past interactions. This engine uses machine learning algorithms to analyze the user's behavior and preferences, generating personalized recommendations that are presented at the time of request fulfillment. This feature not only enhances the user experience but also drives additional sales by promoting content that the user is likely to enjoy.

By employing these advanced processing techniques, the system ensures that media file requests are handled efficiently, securely, and in a manner that enhances the overall user experience.

The user can also send a request to search for a particular media file. This can be through parameters such as the title, artist, genre, and length but are not limited to these criteria. The server 7 will receive the request and search through the content database 3 for the closest matches to the provided search terms. Once the search results are returned to the user, the user can choose a result and request to download or stream the media file.

In an embodiment, the system can use the Hypertext Transfer Protocol (HTTP) to enable communications between the user terminal as the client and the server 7. The user terminal can send an HTTP request to the server using HTTP request methods. This kind of request is usually made through a GET method or a POST method. These requests are sent to the server 7 which will then return a response to the client.

GET requests are used to request data from the server without modifying data. This makes the GET request suitable for downloading the media files from the server. If the requested media file has an unlimited number of plays, then the GET request is the most suitable option as there is no need for the GET request to modify data. The GET request takes the parameters given to it and selects the intended media file stored in the database to download to the user terminal.

The GET requests are not used for any sensitive data such as user account information and payment information. GET requests can be used for requesting a user's media files and their playlists. As stated above, the GET requests are suitable for downloading media files from the server 7 when the user has purchased an unlimited number of plays. The downloaded file can then be played by the user as much as they want.

POST requests can send data to the server to create or update a resource. This makes POST requests suitable for tracking media files with limited numbers of plays. The POST request can also be used to modify a user's information about their account or their purchased media files. However, due to the number of plays for a media file being limited, neither the GET request nor the POST request are suitable for providing the media files to the user.

For media files that have a limited number of plays, the user terminal requests for the file to be streamed using a streaming protocol. The streaming protocol can be HTTP Live Streaming (HLS), Dynamic Adaptive Streaming over HTTP (DASH), or Real-Time Messaging Protocol (RTMP) but is not limited to these protocols.

The server 7 can receive multiple types of requests and based on the request will return a specific response, as well as perform the requested action. The requested action may include downloading the media file, streaming the media file, and updating the user's information or playlists.

The processor implemented step of updating is performed in accordance with various embodiments as follows.

Once a request is received, the server 7 determines what is being requested. GET requests do not result in modification of any data on the server 7, and therefore do not update anything. POST requests can modify data on the server 7, which can result in updates to the content database 3 or the accounts database 13.

A user can use a POST request from a user terminal to change their account information on the accounts database 13 located on the server 7. The POST request provides information about the user's account to allow the server to identify it. Any information that the user wants to modify is also processed. If the requested information is determined to be properly formatted and sanitized, then the information in the database is modified to match the user's request.

The POST request is used when a user purchases a media file or purchases more plays for the media file. If the user purchases the media file directly or an unlimited number of plays, the POST request will modify the accounts database to reflect this. If more plays are purchased but the number of plays is still limited, the POST request will modify the number of plays remaining in the database. The updating of the number of plays allows the server 7 to keep track of how many plays the user still has available.

When a user uses the POST request to request a stream of the media file they want to listen to, the server 7 will decrement the numbers of plays remaining of the media file for that user. The account database 23 on the server 7 will record the remaining number of plays.

In an embodiment, the account database 23 can also record the number of plays that have already been used. This information can be of benefit to the user and also the content distributor. The user can see which media files they tend to play more, which can help them determine their favorite music tracks, while the content distributor can use the data from many users to determine what music tracks are popular and help recommend media files to other users.

The system's process for transmitting media files is designed to accommodate various delivery methods based on user preferences and the nature of the media content. When a user requests a media file, the system determines whether to deliver the file via direct download or streaming. This decision is based on factors such as the user's account status, the type of media file, and the network conditions at the time of the request.

In the case of direct downloads, particularly for media files with unlimited play status, the system retrieves the file from the content database and initiates a secure transfer to the user terminal. The file is transmitted using secure file transfer protocols, such as HTTPS, to ensure data integrity and confidentiality during transit. Upon completion of the download, the user gains full access to the media file, which can be played an unlimited number of times without the need for further communication with the server.

For media files with limited play status, the system typically employs streaming protocols to deliver the content. Streaming allows the system to maintain control over the number of times the media file can be accessed, as the content is not fully downloaded to the user terminal. Instead, the file is segmented into smaller chunks, which are transmitted to the user in real-time. Each chunk is temporarily stored in the user's local buffer and played as soon as it arrives.

The system supports various streaming protocols, including HTTP Live Streaming (HLS) and Dynamic Adaptive Streaming over HTTP (DASH). HLS, for example, breaks down the media file into MPEG Transport Stream (TS) segments, which are then delivered to the user terminal. The terminal assembles these segments into a continuous stream that the user can watch or listen to without interruption. HLS is particularly effective in handling network fluctuations, as it can adjust the quality of the stream in real-time based on the user's available bandwidth.

Dynamic Adaptive Streaming over HTTP (DASH) is another protocol used by the system, which similarly segments the media file into smaller chunks. DASH offers the added advantage of codec flexibility, allowing the system to use different codecs depending on the content type and network conditions. This flexibility ensures that the user receives the best possible playback experience, regardless of their device or network environment.

The system's streaming protocols are equipped with adaptive bitrate (ABR) capabilities, which monitor the user's network connection and adjust the quality of the stream dynamically. For instance, if the user's connection speed drops, the system automatically switches to a lower bitrate stream, reducing the data load and preventing playback interruptions. Conversely, if the connection improves, the system can upgrade the stream quality to provide a better viewing or listening experience.

In some embodiments, the system also supports progressive download, a hybrid approach where the media file is delivered in chunks, but with the entire file eventually stored on the user terminal. Progressive download offers the advantage of immediate playback (similar to streaming) while eventually allowing offline access to the entire media file.

The system's approach to media file transmission is designed to be scalable, accommodating millions of simultaneous users without performance degradation. This scalability is achieved through the use of content delivery networks (CDNs), which replicate the media files across multiple servers globally. When a user requests a file, the system directs the request to the nearest CDN server, minimizing latency and ensuring fast delivery.

Furthermore, the system employs encryption protocols such as AES-128 to protect media files during transmission. This encryption ensures that even if the data stream is intercepted, it cannot be accessed without the appropriate decryption key. The system manages these keys securely, distributing them to user terminals only after successful authentication.

To further optimize performance, the system implements load balancing techniques that distribute incoming traffic across multiple servers. Each server in the cluster is responsible for handling a portion of the requests, ensuring that no single server becomes overwhelmed. This load balancing is dynamic, adjusting in real-time based on the current load and network conditions.

By integrating these advanced transmission methods, the system ensures that media files are delivered efficiently, securely, and with the highest possible quality, providing an optimal user experience.

The system's usage inhibition and permission mechanisms are critical for enforcing access control over media files, especially in scenarios where files are subject to limited play conditions. These mechanisms ensure that media content is accessed in accordance with the terms of the user's subscription or purchase agreement.

Usage inhibition is triggered when a user attempts to access a media file in a manner that exceeds the permissions granted by their account. For example, if a media file is limited to three plays and the user has already used all three, the system will inhibit further access. This inhibition is immediate and is communicated to the user through a user-friendly interface that explains the reason for the restriction.

The system employs a combination of digital rights management (DRM) and server-side controls to enforce these inhibitions. DRM techniques involve embedding usage restrictions directly into the media file, ensuring that the file cannot be played beyond the allowed limit, even if it is copied or transferred to another device. Server-side controls monitor each access attempt, updating play counts and checking them against the user's entitlements in real-time.

Permission to access media files is granted based on the user's account status, which is continuously monitored and updated by the system. The system employs a real-time synchronization process that ensures the user's local play count is always up-to-date with the central accounts database. This synchronization is crucial for preventing discrepancies, especially in scenarios where the user accesses media files from multiple devices.

In certain embodiments, the system may allow a grace period during which the user can continue to access a media file even after their play count has been exhausted. This grace period is designed to prevent abrupt interruptions, allowing the user to complete the current session before purchasing additional plays. The duration and conditions of this grace period are configurable based on the user's subscription level or past purchase behavior.

Additionally, the system may grant temporary permissions in scenarios where the user's account status is under review or when a recent purchase is pending verification. These temporary permissions ensure that the user experiences no disruption in service while the system processes the necessary account updates. Once the review or verification is complete, the system adjusts the permissions accordingly, either maintaining access or implementing the appropriate inhibitions.

Clear communication with the user is essential for maintaining transparency and trust. The system provides detailed notifications whenever usage inhibition occurs, explaining the reason for the restriction and offering options for resolution. For instance, the system might present the user with the option to purchase additional plays or upgrade their subscription to gain unlimited access to the media file.

Notifications are delivered through multiple channels, including in-app messages, emails, and push notifications, ensuring that the user is informed regardless of their current activity. The system also provides a detailed account dashboard where users can view their play counts, subscription status, and purchase history, giving them full visibility into their media access rights.

The system maintains comprehensive audit trails of all access attempts, including both successful plays and inhibited attempts. These logs include timestamps, user identifiers, media file IDs, and the specific reasons for any inhibitions. The audit trails are stored securely and can be used for both troubleshooting and compliance purposes. For example, they provide evidence that the system has enforced usage restrictions in accordance with content licensing agreements.

In some embodiments, the system integrates with external DRM systems to enhance its ability to manage and enforce usage rights. This integration allows the system to support a wider range of media formats and licensing models, providing greater flexibility in how media content is distributed and accessed. The external DRM systems communicate with the central accounts database to ensure that all usage restrictions are consistently applied across all platforms and devices.

The system's inhibition and permission controls extend to shared access scenarios, where multiple users are granted access to the same media file under a shared account or family plan. The system carefully manages the play counts for each user, ensuring that the total plays do not exceed the allowed limit. In cases where a shared access violation is detected, the system may inhibit access for all users under the shared account until the issue is resolved.

To enhance its inhibition and permission mechanisms, the system continuously monitors user behavior and access patterns. This data is analyzed using machine learning algorithms to identify potential areas of improvement, such as optimizing the timing and content of user notifications or adjusting the conditions under which grace periods are offered. By learning from user interactions, the system becomes more adaptive and responsive, offering a more personalized and user-friendly experience.

The system's ability to dynamically inhibit or permit media file usage, based on real-time account data, DRM controls, and user behavior, ensures that content access is tightly managed. This not only protects the rights of content creators but also provides a flexible and transparent user experience.

The information about the number of plays can be used in an algorithm to predict genres or specific music tracks that would be of interest to a listener. This data can be stored in the accounts database 23 and regularly updated based on the listening history of the user. The user's preferences can be extrapolated based on what media files they choose to download or stream, and the number of times each file is played.

The accounts database 23 on the server 7 can both increment the number of times a user has played a particular media file and decrement the number of plays that the user has remaining for that particular media file. For an embodiment, the number will be incremented and decremented by one each time the media file is streamed.

In another embodiment, the user can request multiple plays of the media file which results in incrementing and decrementing by more than one. In this case, the user terminal will keep track of the number of plays performed and then send this information to the server 7 in a POST request to update the accounts database 23. If the number of plays reaches zero, then the media file will stop being streamed and the user will have to purchase more plays.

For media files that have been downloaded by the user to the user terminal, the media file effectively has an unlimited number of plays. The user terminal must be the one to track the number of plays as the file can still be played without a connection to the server 7. The server 7 will receive the number of plays from the user terminal once a connection is re-established. The server 7 will then update the accounts database 23 with the new number of times played. This method can only be used for media files that the user purchased for an unlimited number of plays.

In another embodiment, all media files are to be streamed even if the user has purchased the media file with unlimited play status. Unlimited play status in this context means there is no inherent limit on the amount of times a media file may be played, but does not mean the media file may be played in an unlimited fashion. In this embodiment, the user account has a certain amount of account data, analogous to a cellular phone data plan. The account data is decremented by a certain amount if the user requests to play a media file with limited play status. In this context, a media file with limited play status is specifically limited to a certain number of plays. Once the number of plays has been reached, the user must purchase additional plays to continue playing the media file. If the user requests to play a media file with unlimited play status, the account data is decremented by a higher amount than if the media file had limited play status. Once the account data reaches zero, the user must further purchase account data to continue playing the media files.

The amount of account data decremented can depend on the play status of the media file and the user's account status but is not limited to just these factors. In some embodiments, there is a greater amount of account data decremented when the media file has unlimited play status compared to when the media file has limited play status. In other embodiments, the amount of account data decremented may be the same regardless of the play status of the media files.

The server 7 communicates with the user terminal to keep track of how much account data is decremented and which media file is associated. The account database 23 on the server 7 stores the remaining amount of account data for the user. When account data is decremented by a user playing a media file, the account database 23 is also updated with the new value.

The processor implemented step of transmitting is performed in accordance with various embodiments as follows.

After the server 7 receives a request for playing a media file, the server 7 transmits the media file to the user terminal. The media file may be transmitted in multiple ways, including but not limited to direct file download and streaming the file. The transmitted media files can have a limited, set number of plays or an unlimited number of plays.

The transmitted media files can be transmitted through a network that connects the server 7 and user terminals, particularly the Internet, though any network that allows for a connection between the server and user terminals will suffice. The transmitted files can be transmitted through a wired or wireless connection, such as through ethernet or Wi-Fi.

The Internet connection can be achieved through various means, including but not limited to ethernet, Wi-Fi, and satellite. User terminals such as personal computers tend to possess ethernet ports and Wi-Fi capabilities, allowing for either a wired or wireless Internet connection. Satellite Internet access can allow users that do not have a wired connection to their place of residence to connect to the Internet through a satellite dish. User terminals such as mobile cellular phones also make use of satellites and cellular towers for Internet connectivity.

In an embodiment, the media file may be transmitted through an HTTP GET request. The server 7 will receive a GET request from a client on a user terminal and return a response to the user terminal. The response can include the media file data, allowing the user terminal to download the media file. The media file being downloaded directly to the user terminal means that the file is not limited to a set number of plays and can be played by the user for as many times as they prefer. Thus, the number of plays for the media file can be more difficult to limit using this method. The number of plays can be tracked by the user terminal but the server 7 will not have control over how many times the media file can be played.

In another embodiment, the media file may be transmitted through a streaming protocol such as HTTP Live Streaming (HLS), Dynamic Adaptive Streaming over HTTP (DASH), or Real-Time Messaging Protocol (RTMP), but is not limited to these protocols. Streaming protocols break down the media file into small data packets and transmit the packets to the user terminal in real time. This method also allows the server 7 to control the number of times a media file can be played on the user terminal.

Using the streaming method, the server 7 can transmit the file only when there are still plays remaining for the media file. It can also transmit information about the number of plays to the user, whether it is the total number of plays performed or the number of plays remaining. Furthermore, other user information can be transmitted if the user requests their account information. The amount of account data remaining can also be transmitted to inform the user of their remaining data.

HTTP Live Streaming (HLS) is an adaptive bitrate streaming protocol that can transmit audiovisual content in real time through a network. HLS uses a web server and requires specific software to encode the data into the proper format for streaming. The server 7 encodes the media file into an audio format, which can include but is not limited to Advanced Audio Coding (AAC), MP3, and Dolby Digital Plus (EC-3). The codified file is encapsulated by MPEG Transport Stream. The encapsulated file is then segmented to divide the stream into fragments of equal length. The fragments are transmitted to the client on the user terminal where the file is assembled. HLS contains adaptability features that allow players to maintain smooth playback despite unreliable network conditions. The media file can be made highly available by providing multiple servers for the same file, allowing players to swap between them if one server fails.

Dynamic Adaptive Streaming over HTTP (DASH) is an adaptive bitrate streaming technology that partitions a media file into segments and delivers the segmented media file to a client through HTTP. DASH typically provides multiple representations of the media file with different bit rates to allow the player to seamlessly play the media file even in unreliable network conditions. DASH is flexible because it can be used with any audio codec and any application layer protocol.

The processor implemented step of inhibiting is performed in accordance with various embodiments as follows.

The streaming of the media file to the user terminal can be controlled by the server 7. This allows the server 7 to terminate the stream at any time, for instance when a user's account data is used up. The user terminal will send status updates about the played media file to the server 7. The stream can be terminated or restricted due to various factors, which include but are not limited to account data, network connectivity, and play status.

The server 7 will terminate the stream when it determines that the user has used up all of their account data. The amount of account data remaining is stored on the accounts database 23 on the server 7 and is periodically updated with information from the user terminal. The server 7 and the user terminal will attempt to stay synced. The user will have to purchase more account data to continue the stream. The media player client on the user terminal may provide periodic warnings to the user about their remaining account data.

If the media file being played has a limited number of plays, then once the plays have been used up, the server 7 will also terminate the stream. The number of plays remaining is stored on the accounts database 23 on the server 7 and is periodically updated with information from the user terminal. The number of plays can be increased through purchase. This can be independent of the amount of account data remaining for the user. In other words, the media file streaming can be terminated when either the plays remaining or account data remaining reaches zero.

When the amount of account data remaining starts to approach zero, the system may begin to restrict the quality or priority of the stream to preserve data. This is similar to how cellular data plans for mobile phones operate.

If the content distributor allows for users to continue streaming even after running out of account data, then the users may be bumped to a lower priority compared to those who still have account data. This is a way to inhibit the streaming of the media file to both preserve data and encourage the users to make further purchases. The quality of the stream may also be lowered for similar reasons.

The content distributor may allow for the media file to be streamed for a certain number of times before updating the account database. In this case, the number of times the file was played is stored on the user terminal. Once the number of plays has been reached, the user terminal will send the updated information to the server. This allows for less data transfer while still restricting the user from playing the media file over the limit.

The processor implemented step of permitting is performed in accordance with various embodiments as follows.

When a media file is requested and the server 7 determines that the user's account data is sufficient, and that the media file still has plays remaining, the media file is permitted to be streamed to the user terminal. The server 7 will check the accounts database 23 to determine the account data and play count information.

Media files with unlimited play status that the user has downloaded to the user terminal are permitted to be played for as many times as the user wants. Due to the file being present on the user's device, the media file is independent of the server 7 and content database 3. The user terminal will not need to update the server in this case, though it may still record the number of plays performed.

For streamed media files with unlimited play status, the user may play the media file until they lose connection or run out of account data if applicable. The user terminal may record the number of plays but will not need to update the server 7. The user terminal may send the number of plays to the server 7 for the user's account records.

In some embodiments, the content distributor may allow the user to continue streaming the media file to its conclusion even once account data has run out. Rather than terminating the connection as soon as the account data runs out, the server 7 will continue the stream only once the media file finishes playing. After this, the stream will end and the user will have to purchase more account data to continue accessing the media file.

The system's capability to permit usage is tightly integrated with its secure content transmission protocols, ensuring that only authenticated and authorized users can access media files. Once a user's permissions are validated, the system employs a combination of encryption techniques and secure communication channels to deliver the content. The use of HTTPS for all transmissions ensures that data remains encrypted during transit, preventing interception or unauthorized access.

Upon successful permission validation, the system initiates the decryption process using keys securely managed within the system's Key Management Service (KMS). These keys are delivered to the user's device in a manner that prevents their exposure, even in the event of a security breach. The decryption process occurs in real-time, allowing the user to access the content immediately after permission is granted.

The system supports adaptive streaming technologies that optimize content delivery based on the user's device capabilities and current network conditions. This dynamic approach ensures that users receive the highest possible quality without interruptions, even when network bandwidth fluctuates. The system continuously monitors playback quality and adjusts the stream in real-time, balancing the need for high-quality media with the requirement for smooth playback.

As the user accesses the content, the system performs real-time monitoring to ensure compliance with access policies. Session management features allow users to pause and resume content across multiple devices without losing their place, providing a seamless experience. The system stores session data securely, synchronizing it across all authorized devices connected to the user's account.

For added security, the system incorporates invisible watermarking techniques during content delivery. These watermarks are embedded directly into the media stream and are unique to each user session. This approach not only deters unauthorized distribution but also enables the system to trace any leaks back to the original user. The watermarking process is designed to be imperceptible to the user, ensuring that it does not affect the quality of the viewing experience.

All activities related to content access, including decryption, playback, and session management, are logged in detail by the system. These logs are critical for compliance with digital rights management (DRM) requirements and can be reviewed by content providers to verify that access controls are being properly enforced. The audit logs are protected against tampering and can be used as evidence in the event of a security breach or licensing dispute.

The system encourages user feedback on content access experiences, which is analyzed to identify areas for improvement. Feedback mechanisms are integrated directly into the content playback interface, allowing users to report issues or suggest enhancements in real-time. This continuous loop of feedback and improvement helps the system evolve to meet the changing needs of users and content providers alike.

To ensure that the system can scale effectively with increasing user demand, it is built on a modular architecture that supports the addition of new features and capabilities. This scalability is crucial for accommodating future advancements in content delivery, such as 8K video streaming or virtual reality content. The system is designed to integrate seamlessly with emerging technologies, ensuring that it remains relevant and effective in a rapidly evolving digital landscape.

The system's design supports comprehensive management of the entire content lifecycle, from initial distribution to final consumption. This includes not only permitting usage and secure transmission but also the ability to revoke access if necessary. For instance, if a content provider decides to withdraw a piece of content from circulation, the system can revoke all permissions and prevent further access to the media, ensuring that the content is protected throughout its lifecycle.

By integrating these advanced features with its core permission and transmission capabilities, the system ensures a secure, user-friendly, and scalable solution for digital content distribution. This holistic approach to content management supports the needs of both content providers and end-users, offering a robust platform that adapts to the complexities of modern digital media consumption.

### III. Embodiments for Determining User Permission

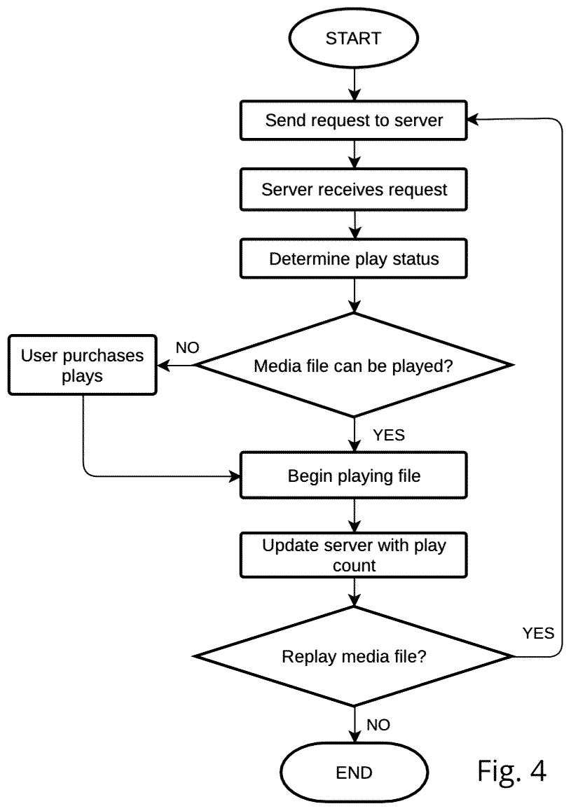

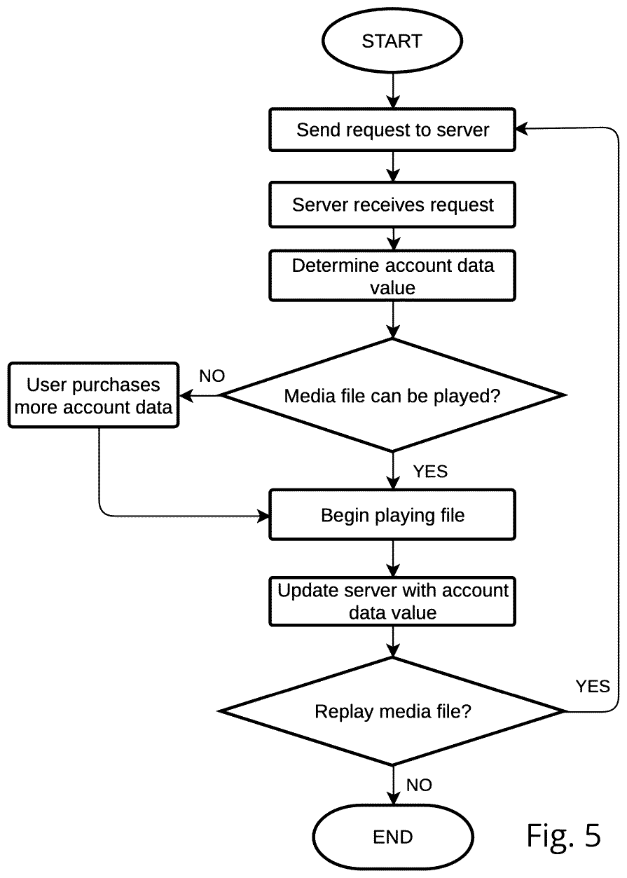

FIGS. 4 and 5 are flow diagrams of steps for determining whether a user has permission, which are discussed in more detail below.

FIG. 4 is a flow diagram of steps for determining whether a user has permission or credits to play a media file in accordance with an embodiment. As shown in FIG. 4, the user requests access from the server to play the media file. If the user does not have enough plays, they may purchase the plays. If they do have enough, the media file plays and the server updates to the current play count.

FIG. 5 is a flow diagram of steps for determining whether a user has permission or credits to play a media file in accordance with an alternative embodiment. As shown in FIG. 5, the user requests permission from the server to play the media. The account data value for the user's plays is then accessed. If this value is not sufficient, the user may purchase more plays. If it is sufficient, or if the user has purchased the necessary plays, the media file is played and then the data value for the user's plays is updated on the server.

### IV. Structural Elements

Certain structural elements are disclosed below.

Exemplary embodiments are intended to cover all software or computer programs capable of performing the various heretofore-disclosed determinations, calculations, etc., for the disclosed purposes. For example, exemplary embodiments are intended to cover all software or computer programs capable of enabling processors to implement the disclosed processes. In other words, exemplary embodiments are intended to cover all systems and processes that configure a document operating system to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed above.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or subnetworks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of a network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or subnetworks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of a network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

The client and server devices are intended to include or otherwise cover all software or computer programs capable of performing the various heretofore-disclosed determinations, calculations, etc., for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed above.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or subnetworks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of a network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

### V. Alternative Embodiments

Although in the above embodiments reference has been made to making unlimited user of a media file 5, it will be appreciated that in some embodiments media files 5 could be made available for use only a limited number of times before additional payment is required. Similarly, although in the above embodiments media files 5 are described as being made available for use by users only once before needing to update their account data to facilitate further use, it will be appreciated that in some embodiments multiple uses before updating account data could be permitted. Thus, rather than facilitating charging on a unlimited use or charge per use basis, the described system could be amended to facilitate any kind of differential charging scheme whereby users were charged differently dependent upon a user selection of status data to be associated with a user and a selected media file 5. of the invention described with reference to the drawings comprise computer apparatus and processes performed in computer apparatus, the invention also extends to computer programs, particularly computer programs on or in a carrier, adapted for putting the invention into practice. The program may be in the form of source or object code or in any other form suitable for use in the implementation of the processes according to the invention. The carrier may be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal, which may be conveyed via electrical or optical cable or by radio or other means.

When a program is embodied in a signal, which may be conveyed directly by a cable or other device or means, the carrier may be constituted by such cable or other device or means. Alternatively, the carrier may be an integrated circuit in which the program is embedded, the integrated circuit being adapted for performing, or for use in the performance of, the relevant processes.

In this alternative embodiment, the system is integrated with machine learning (ML) algorithms to enhance its predictive capabilities. By analyzing user behavior, content consumption patterns, and historical data, the system can predict user preferences and adjust content delivery dynamically. For example, the system might pre-load certain content based on the user's past viewing habits, reducing load times and improving the overall user experience. Additionally, the ML algorithms could be employed to identify potential security threats, such as unusual login patterns or data access anomalies, allowing the system to preemptively secure content before a breach occurs.

The predictive analytics feature also enables the system to optimize resource allocation. For instance, the system could forecast periods of high traffic based on historical data and user behavior, allowing it to scale up resources in advance to handle the expected demand. This proactive approach not only ensures a seamless user experience but also reduces operational costs by optimizing the use of computing resources.

Another embodiment involves the integration of blockchain technology to enhance content security and streamline rights management. By leveraging a decentralized ledger, the system can securely track the ownership and distribution of digital content. Each piece of content can be assigned a unique digital token that is recorded on the blockchain, ensuring that the content's provenance and ownership are transparent and immutable.

This blockchain-based approach also facilitates the automated enforcement of licensing agreements and digital rights. Smart contracts can be deployed on the blockchain to govern the conditions under which content can be accessed or distributed. For example, a smart contract could automatically revoke access to a media file once a user's subscription expires or if a certain number of plays has been reached. These smart contracts are executed autonomously and without the need for intermediaries, reducing the potential for disputes and ensuring that content rights are respected.

In this embodiment, the system is adapted to support the delivery of augmented reality (AR) and virtual reality (VR) content. As AR and VR technologies become increasingly popular, the system can be extended to provide immersive experiences by delivering 3D content that interacts with the user's environment in real-time. The system would include a specialized content delivery protocol optimized for high-bandwidth, low-latency transmission, which is essential for maintaining the realism and responsiveness of AR/VR applications.

To accommodate the unique requirements of AR/VR content, the system incorporates advanced rendering techniques and real-time data processing. These techniques allow the system to dynamically adjust the resolution and quality of the AR/VR content based on the user's device capabilities and network conditions. Additionally, the system could include features that enable users to interact with virtual objects in a 3D space, further enhancing the immersion and interactivity of the experience.

The implementation of AR and VR content delivery also opens up new opportunities for content creators and providers. The system can offer tools for creating and distributing interactive AR/VR experiences, enabling providers to reach new audiences and explore innovative content formats. This embodiment positions the system at the forefront of emerging digital media trends, making it a versatile platform for the future of content consumption.

This embodiment explores the use of distributed edge computing to process content closer to the user, reducing latency and improving the efficiency of content delivery. In this configuration, the system deploys edge nodes in strategic locations, such as within ISPs or at local data centers, to handle content processing tasks that would otherwise be performed at a central server. These tasks could include content caching, real-time encoding, or the application of digital rights management controls.

By processing content at the edge, the system minimizes the distance that data must travel, leading to faster load times and a more responsive user experience. Additionally, edge computing enables the system to offload processing tasks from the central server, reducing the overall computational load and improving scalability. This distributed approach also enhances the system's resilience, as edge nodes can continue to operate independently even if the central server experiences downtime.

Furthermore, distributed edge computing supports the delivery of localized content, allowing the system to tailor content offerings based on the user's geographic location. This capability is particularly valuable for content providers seeking to comply with regional licensing agreements or to offer region-specific content, such as localized news or advertisements. The system's ability to deliver content from the edge ensures that users receive timely and relevant information, further enhancing the value of the platform.

What is claimed is:

1. A computer implemented method of distributing media content within a computer network that includes a communications system; an account database associating users with account data; a content database storing a plurality of media files; and a user terminal, the method comprising:
receiving a download request via the communications system from a user via the user terminal for purchase of a media file stored in the content database, wherein the media file requires purchase according to one of limited play status that allows a finite number of plays of the media file and unlimited play status that allows an unlimited number of plays of the media file, wherein said download request includes data identifying a media file stored in the content database and status data indicative of either limited play status or unlimited play status when the media file is purchased;
updating the account data within the account database associated with a user making the request via the user terminal on the basis of the status information included in the request by decrementing the account data by a first amount if a download request includes data indicative of the media file purchased with limited play status and decrementing the account data by a second amount if a download request includes data indicative of the media file purchased with unlimited play status wherein the second amount is greater than the first amount;
transmitting, via the computer network, data corresponding to the media file identified in the received request to the user terminal, such that complete media files are transmitted and associated with a set number of plays, including limited or unlimited play status, so that the media files are utilized without connecting to the content database to thereby achieve a reduction in data transfer that would otherwise have been required;
inhibiting, via the computer network, the utilization of the transmitted media file more than a predetermined number of times without updating the account database if the download request includes status data indicative of limited play status; and
permitting utilization, via the computer network, of the transmitted media file more than a predetermined number of times without updating the account database if the download request includes status data indicative of unlimited play status.

2. The method of claim 1, wherein inhibiting the utilization of the transmitted media file more than a predetermined number of times without updating the account database if the download request includes status data indicative of limited play status comprises inhibiting the utilization of the transmitted media file more than once without updating the account database if a download request includes status data indicative of limited play status.

3. The method of claim 2, wherein the data corresponding to the media file transmitted in response to a request including status data indicative of limited play status comprises data in a form which prevents the data from being used more than once.

4. The method of claim 2, wherein the data corresponding to the media file transmitted in response to a request including status data indicative of limited play status comprises a data stream which is overwritten subsequent to use thereby preventing the data from being reused more than once.

5. The method of claim 1, wherein transmitting data corresponding to the media file includes transmitting data which identifies the number of times a media file can be used, the method further comprising;
receiving an instruction to play a received media file;
determining the number of times a received media file is permitted to be used on the basis of the data transmitted with the media file; and
utilizing a player to play the received media file if the media file has not been played more than the permitted number of times.

6. The method of claim 5, further comprising:
responding to a determination that a received media file has been played the permitted number of times by:
generating a further download request for said media file;
updating the account data associated with the user making the request on the basis of the generated request; and
transmitting data to the player enabling the player to play the media file at least one more time without updating the account database.

7. The method of claim 6, wherein transmitting data to the player enabling the player to play the media file at least one more time comprises transmitting data identifying the number of additional times the player can play said media file without updating the account database.

8. The method of claim 6, wherein transmitting data to a player enabling the player to play the media file at least one more time without updating the account database comprises transmitting a further copy of the media file to the player to enable the player to play the media file at least one more time without updating the account database.

9. The method of claim 1, wherein updating the account data associated with a user making a request further comprises:
checking whether account data associated with the user making the request exceeds a predetermined amount; and
responding to a determination that the account data does not exceed the predetermined amount by:
presenting a user interface at the user terminal requesting a user to make an additional payment;
updating the account data in response to confirmation that a payment is being made;
and preventing transmission of data to the user terminal to enable the user to utilize a requested media file until the account data has been updated.

10. The method of claim 1, further comprising:
receiving a further download request from a user terminal for a media file;
determining whether a user associated with the user terminal has previously received data corresponding to the media file in response to a request including status data indicative of unlimited play status; and
if so transmitting data corresponding to the media file identified in the received request to the user terminal without updating the account data associated with the user associated with the user terminal.

11. The method of claim 1, wherein the data corresponding to the media file identified in the received request transmitted in response to a request including status data indicative of unlimited play status comprises data in a form which permits the data to be used multiple times.

12. A computer implemented method of distributing media content within a computer network, the method comprising:
providing an account database of the computer network associating users with account data;
providing a content database of the computer network storing a plurality of media files; receiving a play list from a first user via a user terminal of the computer network
associated with the first user, identifying a second user and one or more purchased media files stored in the content database remote from the user terminal, wherein the one or more media files requires purchase according to one of limited play status that allows a finite number of plays of
the one or more media files and unlimited play status that allows an unlimited number of plays of the one or more media files, wherein each of said one or more media files, when purchased, is identified with status data indicative of either limited play status or unlimited play status;
updating account data associated with the first user on the basis of the status data associated with media files in the playlist by decrementing the account data by a first amount if a download request includes data indicative of limited play status when the one or more media files were purchased and decrementing the account data by a second amount if a download request includes data indicative of unlimited play status when the one or more media files were purchased wherein the second amount is greater than the first amount;
transmitting, via the computer network, data identifying the one or more media files in the play list to a user terminal associated with the second user, such that complete media files are transmitted and associated with a set number of plays, including limited or unlimited play status, so that the media files are utilized without connecting to the content database to thereby achieve a reduction in data transfer that would otherwise have been required;
responding to a download request from the user terminal associated with the second user for a media file included in the play list by:
transmitting, via the computer network, data corresponding to the media file identified in the request to the user terminal associated with the second user;
inhibiting, via the computer network, the utilization of the transmitted media file more than a predetermined number of times without updating the account database if a media file is associated with status data indicative of limited play status; and
permitting utilization, via the computer network, of the transmitted media file more than a predetermined number of times without updating the account database if a media file is associated with status data indicative of unlimited play status.

13. A computer network comprising:
a user terminal operable to enable a user to generate a request for purchase of a media file, wherein the media file requires purchase according to one of limited play status that allows a finite number of plays of the media file and unlimited play status that allows an unlimited number of plays of the media file, and associate the request with status data indicative of either limited play status or unlimited play status when the media file is purchased;
an account database associating users with account data and responsive to receipt of a request from a user terminal to update account data associated with a user making the request on the basis of the status data associated with the request by decrementing the account data by a first amount if a download request includes data indicative of purchase of the media file with limited play status and decrementing the account data by a second amount if a download request includes data indicative of purchase of the media file with unlimited play status wherein the second amount is greater than the first amount;
a content database storing a plurality of media files; and
a communications system operable to transmit data between said user terminal; said account database and said content database, wherein the content database is responsive to receipt of a request from a user terminal and the updating of the account database to transmit data corresponding to the media file identified in the received request to a user, such that complete media files are transmitted and associated with a set number of plays, including limited or unlimited play status, so that the media files are utilized without connecting to the content database to thereby achieve a reduction in data transfer that would otherwise have been required, the data transmitted being such to inhibit the utilization of the transmitted media file more than a predetermined number of times without updating the account database if a download request includes status data indicative of limited play status; and
permit utilization of the transmitted media file more than a predetermined number of times without updating the account database if the download request includes status data indicative of unlimited play status.

14. The computer network of claim 13, wherein the content database is configured to transmit data corresponding to a media file transmitted in response to a request including status
data indicative of limited play status as a data stream which is overwritten subsequent to use thereby preventing the data from being reused more than once.

15. The computer network of claim 13, wherein the content database is configured to transmit data corresponding to a media file transmitted in response to a request which includes transmitting data which identifies the number of times a media file can be used; and
wherein a player program is provided on the user terminal which is responsive to receipt of user input to play a received media file to
determine the number of times a received media file is permitted to be used on the basis of the data transmitted with the media file; and
play the received media file if the media file has not been played more than the permitted number of times.

16. The computer network of claim 13, wherein the player program is further configured to respond to a determination that a received media file has been played a permitted number of times by:
generating a further download request for said media file and causing said further download request to be sent to the accounts database; and
wherein the accounts database is responsive to receipt of a said request to update the account data associated with the user making the request on the basis of the generated request; and cause the content database to transmit data to the user terminal enabling a user to play the media file at least one more time.

17. The computer network of claim 13, wherein the account database is configured to be responsive to a request for a media file to update the account data associated with a user making a request by:
checking that account data associated with the user making the request exceeds a predetermined amount;
responding to a determination that the account data exceeds the predetermined amount by decrementing the account data; and
responding to a determination that the account data does not exceed the predetermined amount by sending data to the user terminal to cause the user terminal to present the user with a user interface to make an additional payment, wherein the account database is responsive to receipt of confirmation that a payment is being made to update the account database, wherein until the account database is updated, the account database is configured to prevent the content database from dispatching further data to a user to enable the user to utilize a requested media file until the account data has been updated.

18. The computer network of claim 13, wherein the accounts database is configured to update account data associated with a user making the request on the basis of the status data associated with the request by decrementing the account data by a first amount if a download request includes data indicative of a first status and decrementing the account data by a second amount if a download request includes data indicative of a second status wherein the second amount is greater than the first amount.

19. The computer network of claim 13, wherein the account database is responsive to receipt of a further download request from a user for a media file to
determine whether the user has previously received data corresponding to the media file in response to a request including status data indicative of a second status; and
if so transmit data corresponding to the media file identified in the received request to the user without updating the account data associated with the user.

20. The computer network of claim 13, further comprising:
a further user terminal operable to enable a first user to input data defining a play list identifying one or more media files stored in the content database and associate the identified media files with status data indicative of either limited play status or unlimited play status
together with data identifying a second user;
wherein the account database is responsive to receipt of a playlist to update account data associated with the first user on the basis of the status data associated with media files in the playlist an transmit data identifying the media files in the playlist to a user terminal associated with the second user;
wherein the content database is responsive to receipt of a download request from the second user for a media file included in the playlist to:
transmit data corresponding to the media file identified in the request;
inhibit the utilization of the transmitted media file more than a predetermined number of times without updating the account database if the media file is associated with status data indicative of limited play status; and
permit utilization of the transmitted media file more than a predetermined number of times without updating the account database if the media file is associated status data indicative of unlimited play status.

21. A computer system, comprising:
a control module operable to receive a request for a media file from a user, said request being associated with either limited play status or unlimited play status;
an account database associating users with account data, responsive to receipt of a request for purchase of a media file, wherein the media file requires purchase according to one of limited play status that allows a finite number of plays of the media file and unlimited play status that allows an unlimited number of plays of the media file, from a user to update account data associated with the user making the request on the basis of the status data associated with the request by decrementing the account data by a first amount if a download request includes data indicative of a media file purchased with limited play status and decrementing the account data by a second amount if a download request includes data indicative of a media file purchased with
unlimited play status wherein the second amount is greater than the first amount; and
a content database storing a plurality of media files; wherein the content database is responsive to receipt of a request for purchase of a media file and the updating of the account database to cause data corresponding to the purchased media file identified in the received request to be transmitted to a user, such that complete media files are transmitted and associated with a set number of plays, including limited or unlimited play status, so that the media files are utilized without connecting to the content database to thereby achieve a reduction in data transfer that would otherwise have been required, the data transmitted being such to inhibit the utilization of the transmitted media file more than a predetermined number of times without updating the account database if a download request includes status data indicative of a media file purchased with limited play status; and permit utilization of the transmitted media file more than a predetermined number of times without updating the account database if the download request includes status data indicative of a media file purchased with unlimited play status.

22. The computer system of claim 21, wherein the content database is configured to transmit data corresponding to a media file in response to a request including status data indicative of limited play status as a data stream which is overwritten subsequent to use thereby preventing the data from being reused more than once.

23. The computer system of claim 21, wherein the content database is configured to transmit data corresponding to a media file in response to a request including status data indicative of limited play status together with data which identifies the number of times a transmitted media file can be used.

24. The computer system of claim 21, wherein the account database is responsive to receipt of a further download request from a user for a media file to
determine whether the user has previously received data corresponding to the media file in response to a request including status data indicative of unlimited play status; and
if so transmit data corresponding to the media file identified in the received request to the user without updating the account data associated with the user.

25. A non-transitory computer readable medium storing computer interpretable instructions which when interpreted by a programmable computer cause the computer to become configured as:
a control module operable to receive a request for purchase of a media file from a user, wherein the media file is configured for purchase according to one of limited play status that allows a finite number of plays of the media file and unlimited play status that allows an unlimited number of plays of the media file, said request being associated with either limited play status or unlimited play status;
an account database associating users with account data, responsive to receipt of a request for purchase of a media file from a user to update account data associated with the user making the request on the basis of the status data associated with the request by decrementing the account data by a first amount if a download request includes data indicative of a media file purchased with limited play status and decrementing the account data by a second amount if a download request includes data indicative of a media file purchased with unlimited play status wherein the second amount is greater than the first amount; and
a content database storing a plurality of media files; wherein the content database is responsive to receipt of a request for purchase of a media file and the updating of the account database to cause data corresponding to the media file identified in the received request to be transmitted to a user, such that complete media files are transmitted and associated with a set number of plays, including limited or unlimited play status, so that the media files are utilized without connecting to the content database to thereby achieve a reduction in data transfer that would otherwise have been required, the data transmitted being such to inhibit the utilization of the transmitted media file more than a predetermined number of times without updating the account database if a download request includes status data indicative of a media file purchased with limited play status; and permit utilization of the transmitted media file more than a predetermined number of times without updating the account database if the download request includes status data indicative of a media file purchased with unlimited play status.

26. The computer readable medium of claim 25, wherein the instructions cause the content database to become configured to transmit data corresponding to a media file in response to a request including status data indicative of limited play status as a data stream which is overwritten subsequent to use thereby preventing the data from being reused more than once.

27. The computer readable medium of claim 25, wherein the instructions cause the content database to become configured to transmit data corresponding to a media file in response to a request including status data indicative of limited play status together with data which identifies the number of times a transmitted media file can be used.

28. The computer readable medium of claim 25, wherein the instructions cause the account database to be configured to be responsive to receipt of a further download request from a user for a media file to
determine whether the user has previously received data corresponding to the media file in response to a request including status data indicative of a second status; and
if so transmit data corresponding to the media file identified in the received request to the user without updating the account data associated with the user.
